(19) United States
(12) Patent Application Publication
(10) Pub. No.: US 2009/0307996 A1
(43) Pub. Date: Dec. 17, 2009

(54) Building Board or the Like, Its Manufacture and Use

(76) Inventor: Johann Berger, Neustadtl an der Donau (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/084,332

(22) PCT Filed: Apr. 6, 2006
(86) PCT No.: PCT/AT2006/000141

§ 371 Date: Jan. 27, 2009

(30) Foreign Application Priority Data
Oct. 28, 2005 (AT) A 1764/2005

(51) Int. Cl. E04B 1/82; B32B 7/04; B32B 5/12

(52) U.S. Cl. 52/144; 428/120; 428/113; 156/256

(57) ABSTRACT

The invention relates to a building board or structural unit, especially a structural, wall, paneling or support unit or the like with a multi-layer structure, preferably based on wood or wooden materials, which is formed with two cover layers that are spatially separated from each other and placed parallel to each other and at least one core layer placed between them and joined to them, characterized in that

between two if necessary multilayer cover layers (3, 4) each with a planar layer material, preferably from the wood and wooden material group, as well additionally as metals, textile and fiber materials, cardboard, papers plastics, fiber-reinforced plastics, mineral-based construction materials and rock, an at least single-layer slanted-fiber core layer (5) is placed, which is formed from a material having unitary structuring, preferably formed from wood or wood plastic, whereby the fibers form an angle (+ [symbol] ) to the longitudinal direction of the two cover layers (3, 4) between +25 to 80° and/or an angle (− [symbol] ) of −25 to −80°, and whereby additionally provision is made that the slanted-fiber core layer (5) have a multiplicity of these same positively-slanted and/or negatively-slanted slant cavities (6, 6′) that fully run through, are aslant to the particular fiber direction, preferably of equal size to the other, and preferably uniformly distributed.

Additionally it relates to a procedure for manufacturing and using the building boards.

The present invention relates to a new building board or a new structural unit, especially a structural, wall, paneling or support unit or the like with a multi-layer structure, preferably based on wood or wooden materials, which is formed with two cover layers that are spatially separated from each other and placed parallel to each other and at least one core layer placed between them and joined to them, as well as the manufacture and use of the new board.

There is a large number of plate- and/or beamlike construction, structural, load-bearing, wall and/or paneling units assembled according to various principles that have become known for varying purposes, such as structural units and the like for installation in already existing structures with layered composition for new buildings, development, rehabilitation, equipping or the like of buildings, structures, and the like as well as for mobile structures, partitions or the like, as are used, for example, for exhibitions, meetings, presentations, markets or the like, as well as additionally especially for boards to equip structures and for partitions in structures, with thermal and acoustic linings or the like, for the furniture and exhibition structure industry as well as for lining and facing elements in vehicle, boat and ship construction, for equipping of trailers, mobile homes and the like, or also for auxiliary building and construction devices like formwork in building construction and the like, and with an ever greater range for usage.

Success has now been achieved based on specific experience gained in practice, as well as on extensive series of trials as part of appropriate development work, in producing new types of building board or building units or the like of the type named initially with considerably reduced weight and considerably improved values in terms of strength, acoustic and thermal absorption as well as other favorable physical, construction technical, physical and biological feature values, which, especially when produced—as is done in the especially preferred manner—from biological material, or at least predominantly from it, and thus especially with natural, thus grown, woods or wooden materials based on such, are distinguished by having high usage quality and environment-friendly features, and additionally by biodegradability and thus high quality in terms of waste disposal.

The subject of the invention is building boards or structural units as initially mentioned, as well especially as support, structural, wall, paneling and thermal, acoustic, and fire resistant elements and the like according to the preamble of

claim 1, which, in the characterizing part of this claim show disclosed features and combinations of features.

Due to the invention-specific, mandatorily provided transverse direction of the fibers and texturing of the core layer, and in fact expressly not essentially perpendicular, but rather, quite purposefully, at an acute angle to the main direction of the new building boards, it is possible to effect a transverse diffusion of moisture and the like with a compensatory effect which is valuable in construction physical and biological terms, while fully maintaining high mechanical strength and resistance force, vibration damping and thermal insulation properties. At the same time, with the new building boards, new structural units have especially high mechanical load-bearing capacity and carrying capacity, and particularly load-bearing capacity per unit of surface area.

Wood tends to contract or expand very slightly in the fiber direction, for example when there is a change in ambient moisture, and at most is about 1%. When environmental conditions change, due to the slant of the fibers, nonetheless a relative constant thickness of the slanted-fiber core layer is ensured that preferably is considerably thicker than the cover layers, and thus of the entire structural unit or of the entire new building board.

The new building board or the new structural unit or the like makes it possible to a great degree to use more low-value woods, scrap wood, and especially also lightweight woods, each of which is customary, and is to the extent possible cost effective and advantageous to match the market situation, for the core and thus slanted fiber layer that is relatively thick and thus with a relatively high share of the overall volume as compared with its cover layers. In every case, thereby substantial cost reductions are achieved from the outset, without having to make allowances for disadvantages regarding stability and strength of the new building board or units.

A considerably greater advantage is that, as a result of the “slanted direction” of the fibers or texturing, in the slanted-fiber layer, woods with relatively small density and/or transverse strength can be used, which nonetheless are highly stable against effects of pressure aslant to the fiber direction. By this means, mechanically stable building boards are achievable with low volumetric densities not previously attained. Also, the new boards, supports and the like can be thin, if this is required or desired. It should be emphasized that the term “Building board” that is often used here in no way relates solely to structural formwork and paneling boards for structures, but rather is to be understood generally as boards for various other purposes, such as for the construction, room,

accessory, furniture and facilities industries, as well as for varied support and partition units and the like for construction and other purposes, such as for equipment which houses sound systems.

According to the embodiment form provided as part of claim 1, in accordance with ever-increasingly demanded substantial reductions in weight and mass of new building boards or structural units and the like, and that their handling-friendliness and mobility be considerably improved thereby, with high stability and mechanical strength, provision is made that the slanted-fiber layer—preferably formed from wood—be provided with a multiplicity of slanted cavities, recesses, millings, boreholes and the like. These are fully interspersed, with a direction of the slanted fibers or texturing of the material forming this layer, preferably wood, that essentially is aslant to the longitudinal direction of the covering boards, at least in essence corresponding especially to the parallel direction of same.

The advantage of this especially preferred embodiment form within the invention's framework is that it has been found that owing to the slanted cavities in the slant-fiber core layer that are oriented to conform with the slanted fiber direction, it is possible to considerably reduce the weight of the new building board. However, as would possibly be to be expected, the strength of the board does not at all drop dramatically. In addition, the (moisture) transverse diffusion capacity and the moisture compensation is considerably increased by the plate, which is favorable in construction biological terms.

As a precaution it is here indicated that especially when use is made of plastic-bound wood, so-called “wood plastic,” the slanted placement of fibers in wooden material of the core layer is dispensed with. But due to the high density of the material, this plays no special role; however the “slanted direction” of the many cavities in these core layers is important.

Claims 2 to 9 relate to various preferred embodiment forms of the new building boards, whereby as per claim 3 and 4 value is attributed to the possible use of wood plastic with slanted-cavity core layers, and this material fundamentally is considered for all embodiment forms of the building boards according to the invention.

From claims 10 and 11 more detailed data can be gleaned regarding the embodiment forms preferred for design, quality and properties of the new building boards and structural units within the invention, the favorable shaping and distribution of vertical cavities as well as dimensional relationships preferably to be maintained between

cavity volumes and wood mass in the slanted-fiber or slanted-cavity layer.

The following very substantial advantages of the new building boards and their processing and treatment are: due to the slanted placement of cavities, and in the case of the woods, also of the fibers, and thus of the remaining wood material of the core layer, the boards can be screwed, nailed, drilled, processed and the like in the customary same way as wood or wood fiber material or wood plastic. This is because every screw in every instance is anchored between the slanted cavities in the wood material, due to the slanted placement of the multiple fixed wood mass ribs or the like. If the core layer is formed with “positive” and “negative” slanted-fiber or slanted-cavity strips, a greater homogeneity of plates is ensured. Due to the slanted position of the cavities, also the top layer is joined with the large wood surfaces of the core layer, and in straight sections there is no danger that a cavity will be cut longitudinally. Additionally it is very important that, due to the slanted position of the solid wood material or the ribs between the cavities, the wood or the wooden material also lies aslant on the side surfaces. Therefore, more wooden material available for gluing of the lateral flanks of the new boards and also on the short edges of same, and thus, especially the edges area are also very stable and secure.

In using wood in construction, it is very important to keep fire prevention in mind:

With the layering of the interior walls of the slanted cavities using an intumescent polyester mass, which can be done simply with small thickness layers, preferably by spraying from nozzles briefly inserted into these cavities while the production process is going on, in case of a fire, the fire is prevented with great reliability by the cavities being filled with the polymer that foams up when heated, especially in that air is prevented from penetrating in.

Additionally, according to claim 13, the slanted cavities can be filled with a particularly low-density foam. On the one hand, this enhances fire prevention, and on the other hand, residual particles from the processing are prevented from crumbling out of the slanted cavities and interfering with bonding.

Especially preferred features in regard to cost-effective manufacture as part of the invention are the embodiment forms described in detail in claims 14 to 18 of slanted fiber strips for the formation of

a slanted-fiber or slanted-cavity layer in the new building boards, structural units or the like.

As part of a further increase in mechanical strength and warp stability, claims 19 to 21 disclose advantageous embodiment forms of the new building board or the like, in which, within the slanted-fiber layer, “standup” stiffening or reinforcement strips that enhance strength, preferably consisting of wood, are placed. However, in special cases other materials such as plastics or metals such as in safety plates, can be considered.

Claims 22 and 23 disclose advantageous embodiment versions of the cover layer relative to the reinforcement strips and advantageous wood materials in regard to maximum weight reduction for the slanted fiber-slanted cavity layer of the new building board, of the new structural unit or the like.

Claim 24 relates to the preferably used woods that are the same as each other or different for the cover layers of the building boards.

As regards the lateral covering, thus the covering of the narrow-side flanks of the new building boards or structural units or the like, claim 25 provides more detailed information about it.

The subject of claim 26 is a linear curved building board, that can be used for arched structures or paneling of arched structures.

In no way does is the invention limited to boards and the like for the various purposes already named. It is further directed to support units, brackets and the like in the construction trade, and thus predominantly to structural elements with a load-bearing function that extend longitudinally. These combine in themselves the advantages of high mechanical strength with the favorable characteristic properties of wood.

Claims 27 and 28 disclose multiple specifically goal-directed and goal-meeting forms of the new building boards or structural elements or the like. On the one hand, these can be used as acoustic absorber elements or plates, and on the other hand as components that generate or amplify sound or for resonance in public address systems, sound reproduction devices and production of instruments. They also can find use for an entirely different purpose, namely for highly stable door leaves for intruder-proof doors or the like.

Acoustic absorber plates according to claim 27 are installed in residential and workplace spaces such as studio rooms. Therefore, wood whose chief characteristic is fire protection is preferred for this: it has now been found that if the inner walls of the slanted cavities of the slanted-fiber layer are provided with a thin layer of fire-preventing polymer, if the thickness of the board, which consists entirely of wood, is

only 2 cm, and accordingly its slanted cavities have a depth of only about 1.5 cm, this is perfectly acceptable to prevent fires with no problems. In any case it corresponds to fire prevention class F90 (preventing a fire for at least 90 minutes). However, in most cases it far exceeds this value of F90.

Generally, in connection with the fire protection of the new boards, the following may be said:

For example, in a building, the ceilings may be configured to be multilayered in a sandwich construction configuration, with building boards made exclusively of wood as per the invention. Appropriate tests have shown that it suffices to place a thin board of the invention-specific basic design that was just described, with the fire-resistant polymer in the slanted cavities, on the side that is affected or endangered by possible fire, thus, in ceilings, for example, on the visible or underside. In this simple way, full fire protection is provided, though the wooden building boards that are laminated to each other and which themselves form the ceiling in multiple layers do not need to have any fire-protection coating or the like. Naturally, fire-protection building boards provided with a fire-protecting polymer can also be placed on both sides of a ceiling as was just described.

As regards the particular embodiment form the new building boards named in the second part of claim 28, this is especially suited for load-bearing floors, ceilings, wall units and the like, in which there is a requirement for increased fire protection. Such boards can also be used in railway, motor vehicle, ship and aircraft construction, and further for installation in transport structures such as tunnels, for security door leaves and the like.

As part of the invention, claim 29 relates to especially preferred embodiment versions of wall, partition and ceiling units or the like, with high thermal and sound attenuation, using the invention-specific building boards, especially in their basic form.

In accordance with the above presentations about attaining great fire protection safety, one embodiment form of the building boards, structural units or the like, according to claim 30, is especially preferred, whereby the required F90 fire safety values are always attained, but are mostly exceeded considerably, so that all doubts about wood as the basic material that underlies the new building boards or structural units, are dispelled. As regards the advantageously highly flame and fire resistant wood according to this claim,

here there is an advantage in that it totally suffices for the vertical fiber layer to use fireproof wood such as oak, which can be of quite inferior quality, for which otherwise virtually no application has been found until now, and which therefore is obtainable at favorable cost.

Claims 31 and 32 relate to further advantageous embodiment forms, each directed to special types of usage in construction, of wall and ceiling units or the like, according to the invention with use of the new slanted-cavity building boards.

From claim 33 can be gleaned an especially mechanically stable, structure-providing building board, provided with the high acoustic and thermal attenuation properties according to the invention.

Claims 34 and 35 have as their subject the wall and ceiling units or boards or the like as described above, their surfaces providing for a secure attachment to the load-bearing concrete or the like—among other things with a slanted-fiber core layer according to the invention as an adhesion-mediating layer and as a plaster base, that can be provided with a plaster layer or already provided with a ready plaster coating.

Claim 36 relates to wall elements or the like equipped with thermal and acoustic insulation, which can used as manufactured at the site, and thus directly, at the installation site or already produced as a completed element.

In claims 34 to 36, reference is especially made to the option of using invention-specific slanted-cavity core layers of low thickness and without covering layers as plaster base.

Claims 37 and 38 have as their subject manipulation-friendly wall elements, wall board or the like that are distinguished by low weight, and which are especially suited for light structures, installations in buildings, for exhibition purposes, for structures at fairs and the like, which often change location, and whose visible or surface configuration is formed with conventional means or in a manner known per se.

According to the invention, claims 39 to 43 relate to especially advantageous procedures, distinguished by highly economical production methods, for manufacture of especially favorable main implementation versions of the new building boards, and in fact for especially preferred instances within the invention's framework, that they are formed as an overall unit or at least predominantly with wood or wooden materials. Here brief mention should be made that the procedure according to these claims, despite

an apparently expensive, multi-stage procedure, is nonetheless distinguished by highly economical production, since all the procedural steps can be fully automated with no problem and thus the personnel expense can be minimized.

Claims 44 to 53 relate to the use of the new building boards with a slanted-fiber and slanted-cavity core layer for various purposes.

Finally, claim 54 places the new slant-fiber and slant-cavity core layer itself without covering layers under protection.

Using the drawings, the invention is explained in greater detail:

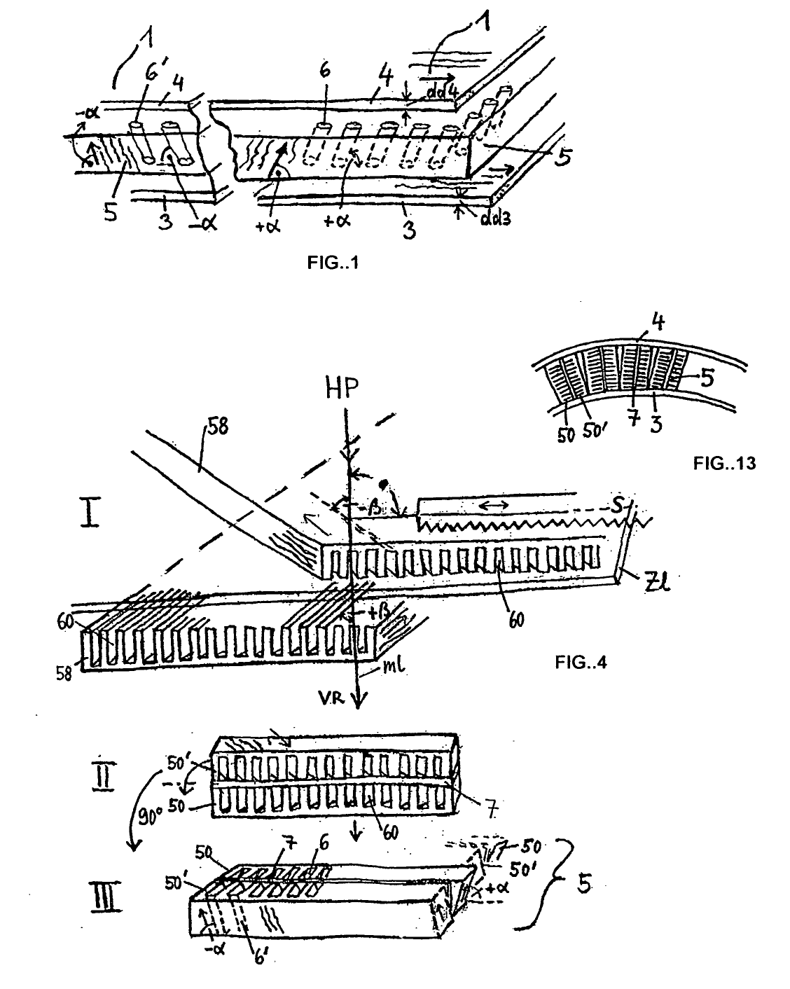

FIG. 1 shows the basic design of the new building board with a slanted-fiber and slanted-cavity core layer.

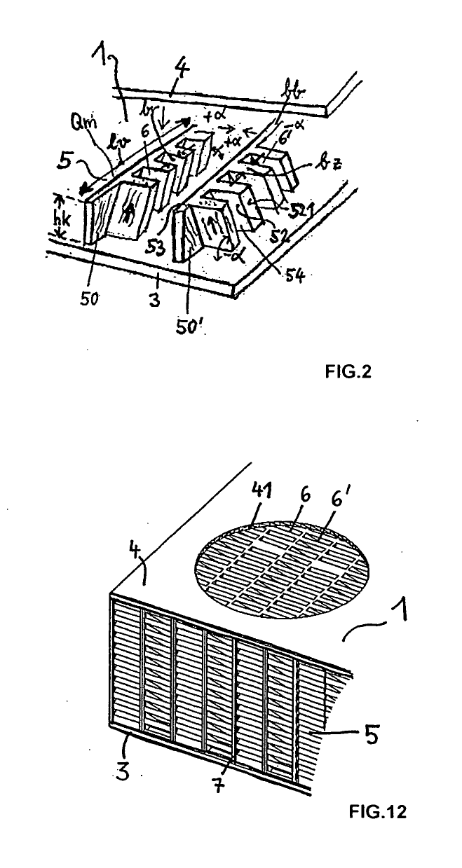

FIG. 2 shows a preferred new building board, whose core layer is formed by positive and negative slanted-fiber strips that lay one upon another.

FIG. 3 shows a building board with a slanted-fiber core strip formed with two partial layers.

FIG. 4 shows a preferred type of manufacture of slanted-fiber strips and their placement for forming the slanted-fiber core layer of the new building board.

FIG. 5 shows in detail the manufacture of a building board in stages.

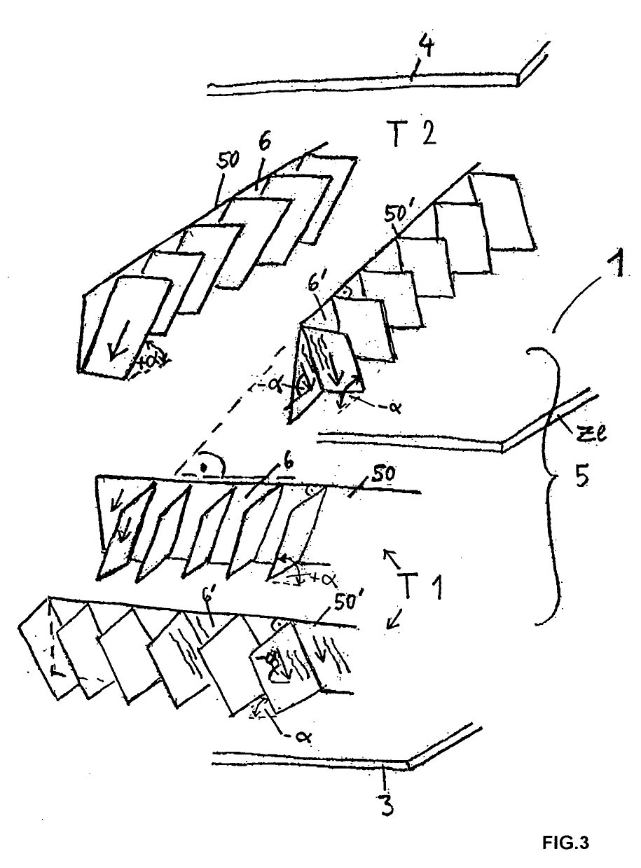

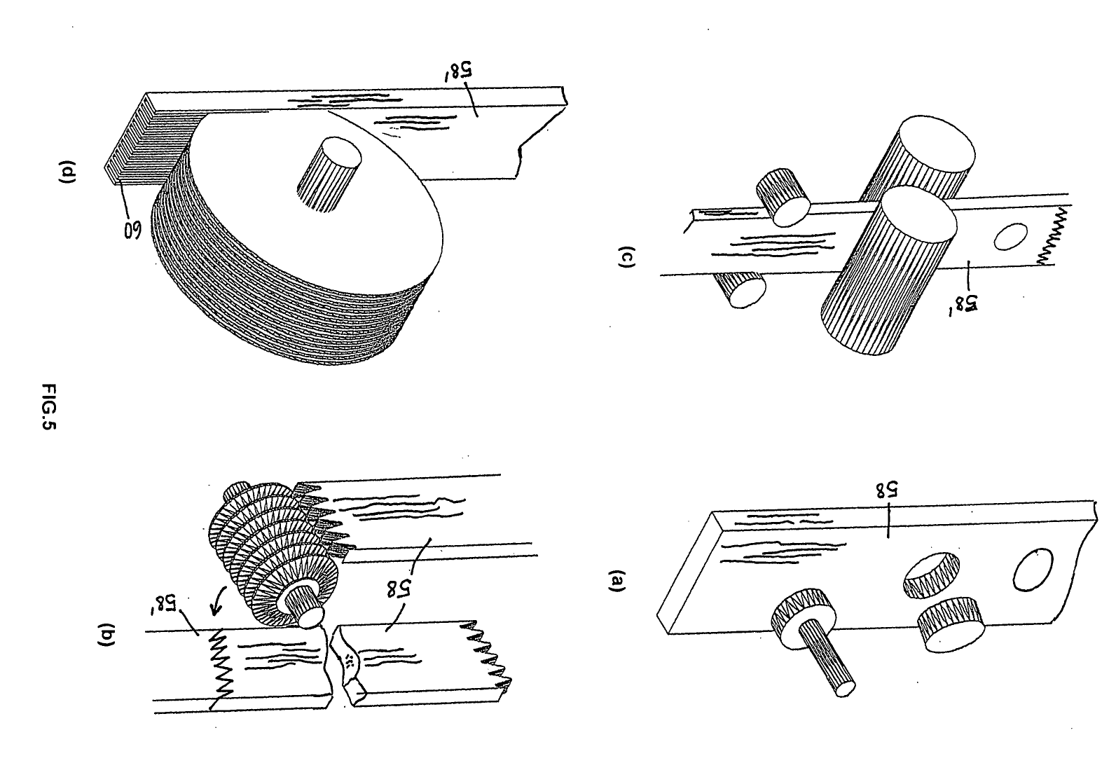

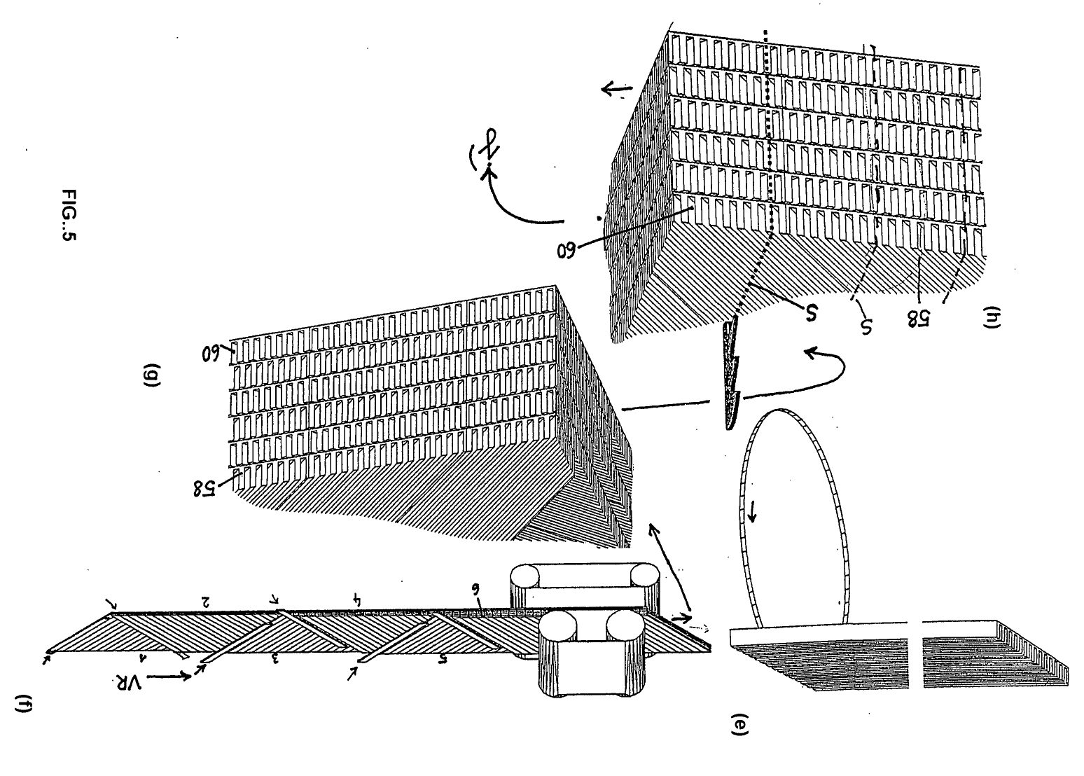

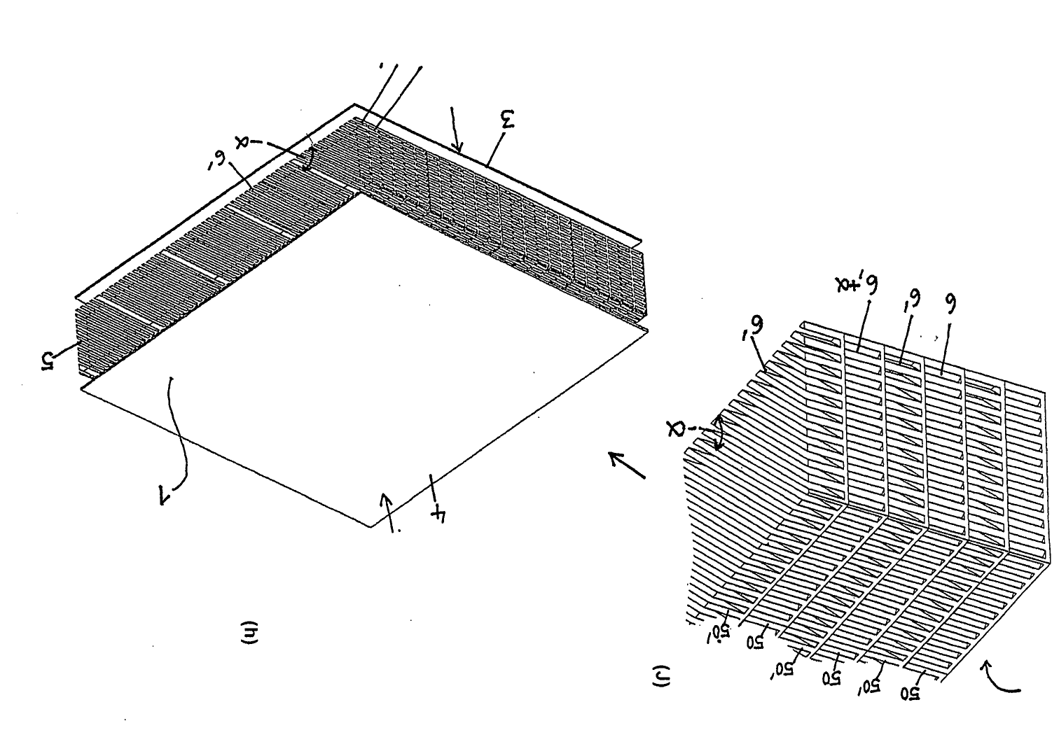

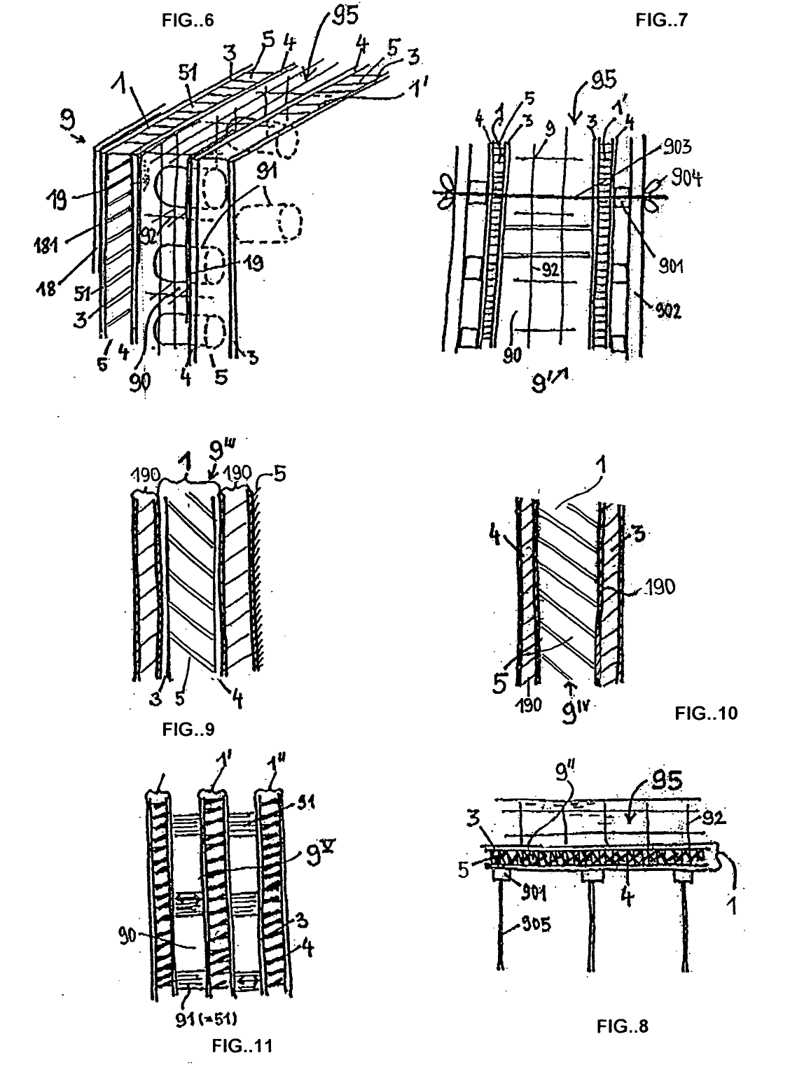

FIG. 6 shows a slanted view of a wall unit equipped on both sides with the new building board.

FIG. 7 shows a side view through a wall piece using the new building board, in the manufacturing phase, at the site.

FIG. 8 schematically shows the on-site production of a concrete ceiling equipped from the outset according to the invention with the new acoustic and thermally damping building board according to the lost formwork principle.

FIGS. 9 and 10 show two partition units based on the new building board.

FIG. 11 shows a triple-layer wall unit in cross section, made with the new building board.

FIG. 12 shows a slanted view of a building board embodied as a sound-attenuating board according to the invention, and

FIG. 13 shows a building board with curved shaping.

The new building board 1 shown in FIG. 1 has a lower cover layer 3 and an upper cover layer 4, between which a slanted-fiber core layer 5 is placed, whose positive slanted texturing here is at a positive angle + [symbol] which is 25 or 30 to 80°, especially 40 to 60°, preferably 40 to 50°, and particularly about 45°, to the longitudinal direction of the lower cover layer 3. The two cover plates 3, 4 here have the same texturing direction, as shown, from right to left, and the same layer thicknesses dd3 and dd4. However, thin homogenous layers or wood plastic layers with no clear fiber direction can very well be used as cover layers 3, 4.

Parallel to the slanted positive fiber direction, likewise indicated, of the

slanted-fiber core layer 5, positive-slanted slant cavities 6 are placed in same, preferably uniformly distributed and preferably all shaped the same—here having a round cross section, for example. In the same way as the fibers of the slant-fiber core layer 5, these here assume a positive angle + [symbol] to the lower cover layer 3. Layers 3, 4 and 5, with a glue capable of thermal activation, for example, are joined together two-dimensionally.

On the left side in FIG. 1, a building board 1 that otherwise is of exactly the same kind is indicated with negatively-slanted slant fibers and negatively-slanted slant cavities 6′ in the slanted-fiber core layer 5, whereby the negative slanted fibers and the negative slanted cavities 6′, parallel to same, here assume the same, “negative” acute angle − [symbol] true, directed toward the other side—to the longitudinal direction of the lower cover layer 3. In especially preferred fashion the angles + [symbol] and − [symbol] are + or −45°.

It is advantageous if the walls of the slanted cavities 6, 6′ are sprayed or coated with an intumescing fire protecting mass.

FIG. 2, with the meanings of the reference signs remaining otherwise the same, shows a positive slanted-fiber strip 50 whose positive-slanting structuring and positive-slanting slanted cavities 6 assume a positive acute angle + [symbol] to the lower cover layer 3 and a right-side, negatively-slanted slant-fiber strip 50′, whose negatively-slanted structuring and negative slanted cavities 6′ assume a negative, and here equally large angle − [symbol] to the lower cover layer 3.

The positive and negative slanted-fiber strips 50, 50′ are placed so as to lie, for example, alternately along each other in the opposing depicted setting—expanded, it is true in FIG. 2—and glued to each other. Ultimately they form a slanted-fiber core layer 5 with a multiplicity of positive and negative slanted-fiber strips 50, 50′ that lie along each other. On the lower and upper side, the slanted-fiber core layer 5 is joined in material-locking fashion with the two cover layers 3, 4, whereby a lightweight board 1 is produced. As a result of the slanting position of the ribs between the slanting cavities 6, 6′, it ensures an outstanding anchoring of attachment devices such as screws or the like, and at the same time has a high overall homogeneity in regard to strength.

FIG. 2, with the meanings of the reference signs remaining otherwise the same, schematically shows one of the slanted fiber strips 50, 50′—that in multiples form the slanted-fiber layer, joined to each other, as shown in FIG. 1—in an expanded view: in the form shown here, they have essentially a beam base form with a length Iv. The height hk of the strips 50, 50′, depending on the desired overall thickness of the building boards, is

variable. The slanted-fiber strips have a comb-like cross section with base or comb beams 53 on slanted tooth extensions 52 with end surfaces 531, that project away perpendicular from them and end freely, and here are also shaped the same. Here also between the tooth extensions 52, inserts or interdental spaces 54 and 6, 6′, likewise identically shaped, are placed. They ultimately form the positive and negative slanted cavities 6, 6′ in the slanted-fiber core layer 5. The comb beam 53 has a width bb, the tooth extensions 52 have a width bz, and the interdental spaces 54, 6,6′ have the width br between same. In favorable fashion the widths bb, bz just mentioned can be equal to each other. The overall cross sectional surface of the wood mass of the slanted-fiber strips 50, 51 is designated by Qm.

Especially high strength is manifested according to the invention by building boards 1 with two layers T1 and T2 encompassing slanted-fiber core layers 5 with cover layers 3, 4 as they are shown schematically and expanded in FIG. 3, where the significance of the reference signs otherwise remains the same. The lower partial layer T1 is formed with negative and positive slant-fiber slanted-cavity strips 50, 50′ that alternate one to one, that are placed roughly parallel to the observer. To this first partial layer T1, here an intermediate layer Zl of wood is joined, and to same is directed an identically built second upper partial layer T2, whose slanted-fiber slant-cavity strips 50, 50′ of the first partial layer T1, are directed, and in a perpendicular orientation in fact to the positive and negative slanting-fiber strips 50′, 50, thus toward the observer. With this arrangement turned 90° toward each other of the partial layers T1, T2, particularly high strength, stability and overall homogeneity is attainable for the new building board 1.

Here it should be emphasized that the second partial layer T2, depending on the usage, can be placed so as to stand at any other angle than a right angle to the first layer T1, thus for special purposes it can also be placed parallel to the first partial layer T1, for example. The arrangement of the intermediate layer Zl is not at all mandatory.

FIG. 4 explains a preferred embodiment form of the manufacture of core layer 5 of the new building boards. It is not shown there in greater detail that first, in the planks 58 in the longitudinal plank direction, and thus in the fiber direction, grooves 50 parallel to the fibers are cut in.

Instead of the grooved planks 58, planks of that type can be used that are manufactured by extrusion from the outset with longitudinal grooves 60.

It is shown how in each case at an angle of + [symbol] and − [symbol] preferably +45° and −45° to the center line ml, which simultaneously is the processing direction VR or continuous forward motion direction of each plank 58 placed aslant. It is shown how, though a hot press HP not shown, two planks 58 with grooves 60, that lie one above the other are inserted, crosswise to each other, in processing direction VR. Additional grooved planks 58 are continuously inserted, lateral to the planks 58 directly adjoining, running crossed one above the other and to each other in the same manner.

In the procedure shown in FIG. 4, between the supplied layers placed one above the other of grooved planks 58 inserted crosswise to each other, thin intermediate-layer planks Zl are continuously inserted that are made for example from homogeneous wood. In addition, here the planks 58 are placed with their grooved openings turned toward each other. Here it ought to be emphasized that it is not at all mandatory to insert the interlayer Zl. Without an interlayer, it is favorable if the grooves 60 of planks 58 of the two layers are only directed toward one same side.

In this place it should especially be emphasized that the grooved planks 58 can also be used in every other position of their grooved openings, thus for example in the same direction of open grooves 60. Additionally the interlayers Zl can be inserted and situated in whatever way desired, and within a wide range, the angles + [symbol] and − [symbol] can be varied to the center line ml or to the direction of production VR. It is especially preferred if these angles + [symbol] and − [symbol] lie in a range between 40 and 50°, thus the longitudinal direction of the fibers and grooves of each of the two planks 58 run crossed into the hot press essentially are placed perpendicular to each other.

After running through the hot press HP provided to join the two plank layers—shown placed in FIG. 4 at the beginning with cuts S, symbolized by a sawblade symbol, perpendicular to the processing and forward motion direction VR or to the center line ml each in the desired strength or thickness of the later core layer 5, (dual) slanted-fiber strips 50, 50′ are detached, for which see Phase II.

Here it is well visualized how, from the interlayer planks Zl of phase 1, the reinforcing or stiffening strip 7 has been formed.

Toward Phase III, the (dual) slanted-fiber strip 50, 50′ is here turned forward by 90°—see the arrow—and further (dual) slanted-fiber strips 50, 50′ are placed on same, side on side, and on the long side and broad side, and joined together by means of glue or the like to each other.

The (dual) slanted-fiber strips 50, 50′ joined to each other ultimately in two dimensions, form in total the slant-fiber core layer 5, onto which then on the underside and top side, both of the cover layers 3, 4—here not shown—are joined or hot-glued.

A fire-protection-mass layer is favorably inserted into the grooves 60 of the planks 58 just after the groove-cutting tool during the production of the longitudinally grooved planks 58 or when wood plastic material is inserted after leaving the groove-forming press matrix.

In the same way, the glue is applied to the planks 58, to the interlayer Zl and later to the cover layers 3, 4, each at points favorable for this of the new continuous manufacturing process. The adhesive is hardened, or activated and hardened, in favorable fashion by blowing hot air into the grooves 60 or into the slanted cavities 6, 6′ formed from same.

Using FIG. 5, a more detailed description is provided of a preferred rational manufacture of a building board, starting from plank 58 to a completed building board 1 in steps a to k as an example:

Step a: remove branches from the planks 58 and patch up existing branch holes while they are run through;
Step b: mortise the planks 58 for the formation of planks of the desired length by means of a dovetailing device, and fit together into an “endless” plank
Step c: plane the four surfaces of the “endless” planks 58 by means of surface and side dovetailing devices
Step d: cut the grooves 60 that are parallel to each other—here rectangular ones—into the “endless” planks 58 in the longitudinal direction and parallel to the wood fibers
Step e: Make a 45° slant cut and clip off the ends of the grooved planks 58 using a circular saw or the like.
Step f: form a sextuple mat by consecutively applying layers of the named planks 58 that lie one behind the other, at angles that alternate after each other of +45° and −45° to the operating movement direction VR and—not shown—glue the layers to each other by a cycle hot press.
Status g: the sextuple mat formed in step f made of six layers of planks 58 alternately crossed to each other by 90° with grooves 60 also thus arranged to cross.
Step h: Guide steps S by means of a saw parallel to the front surface of the sextuple mat at intervals from each other, which correspond to the desired thickness of the building board to be produced.

### Step and

Status j: tip the sextuple slanted-fiber strip 50, 50′ formed in step h by 90° forward or to the right, and laterally glue of the sextuple slanted-fiber strips 50, 50′, 50, 50′, 50, 50′ to core layer 5, not shown
Step k: glue the upper and lower cover layers 3 and 4 to the slanted-fiber core layer 5 formed by sextuple strips 50, 50′ while forming building board 1.

If desired, follow this by covering the side flanks with lateral layers made of wood, for example.

With the meanings of the reference symbols otherwise remaining the same, FIG. 6 shows a slanted view of forming a wall unit 9 with two new building boards 1 and 1′ that limit same and function as paneling boards, for example as thermal attenuation boards, as described previously.

The two building boards 1, 1′ whose inner sides essentially function here as formwork boards, are placed with position stabilization at an interval to each other, whereby the interval 90 between same is traversed by uniformly distributed space-maintaining elements 91 which here are formed by tube pieces made, for example, of plastic, that make a bridge over same. Stiffening rods 92 are inserted into the interval 90.

On the inner side, the building boards 1, 1′ can be provided with an adhesion-promoting layer 19, based, for example, on epoxy resin with a sand covering, that resists moisture and in a preferred manner permits moisture to pass through.

Then in the interval 90 between the two building boards 1 and 1′, lightweight concrete 95 is inserted, for example, where it is cast around the distance-maintaining pipe pieces 91 that remain free in its interior, and the concrete 95 binds to the building boards 1, 1′ that here form a so-called “lost formwork.”

After the concrete 95 hardens, a stable wall unit or one such ready wall element 9 is obtained, that is provided on both sides with completed thermal and acoustic paneling boards 1, 1′. On the outer side the plates 1, 1′ can be provided with a plaster base 181 by a plaster net or also with a ready plaster 18. Especially preferred is the use of a thin slanted-fiber slant cavity core according to the invention without cover layers as a plaster base 181.

The forming of space-maintaining elements 91 as hollow tube pieces has an advantage in that there also vapor can be diffused transversely through the wall 9. Naturally any other type of spacer element 91 can be used.

With the meanings of the reference symbols otherwise remaining the same, FIG. 7 shows the actual procedure for on-site production of a wall unit shown in FIG. 6 or one corresponding to it, or a wall piece 9′. There it is shown how the two building boards 1,1′—initially serving as formwork boards and ultimately forming the paneling of the wall piece—are held in position on the outer side against distortion, especially bulging, by means of holding beams 901 and 902 or the like, and by through-running screw shafts 903 with wing nuts 904, before the intermediate space 90 between plates 1 and 1′ that accommodate the reinforcing iron 92 is filled with concrete 95 or the like.

With the meanings of the reference symbols otherwise remaining the same, FIG. 8 schematically shows the manufacture of a ceiling 9″, in that the ceiling 9″ is cast with concrete 95 onto a building board 1 according to the invention, by means of screwed supports 905 and retaining beams 901—again “lost formwork”—after placement of the reinforcing iron 92. After consolidation of same, the support structure 901, 905 is removed, and a ready concrete ceiling 9″ is obtained, provided for example with a sound-attenuating or acoustic paneling on the ceiling.

With the meanings of the reference symbols otherwise remaining the same, FIG. 9 shows an additional wall unit 9′″, that is formed by a building board 1 and commercially available sandwich-type plaster boards 190 joined on both sides to same. The right sandwich plaster board has a thin slanted-fiber slant cavity core layer 5 according to the invention as a plaster base.

In place of the sandwich plaster board 190, highly fire-resistant fire protection mineral fiber boards can be applied, and in this way a wall with F90 fire retardance can be created, especially if the cavity 6 of core layer 5 is coated with an intumescing fire protecting mass.

With the meanings of the reference symbols otherwise remaining the same, FIG. 10 shows a still simpler building board 1, as a partition element 9^{IV} directly employable for example as such, in which the two cover layers 3, 4 are formed on the slanted-fiber slant cavity core layer 5 itself with the sandwich plaster board 190 or the like.

With the meanings of the reference symbols otherwise remaining the same, FIG. 11 shows a wall unit 9^{V}, with three building boards 1, 1′, 1″ placed parallel to each other at an interval from each other, in which spacer elements 91 are placed in the two intermediate spaces 90 between each of the plates 1, 1′, 1″. These spacer elements 91 are for example arranged from multiple appropriately simply embodied slant-fiber bodies 51 joined to each other, as are shown in principle by FIGS. 1 and 2.

With the meanings of the reference symbols otherwise remaining the same, FIG. 12 shows a building board 1 embodied as an acoustic or sound-absorbing paneling board for acoustically neutral spaces. This differs from the building board shown for example in FIG. 1 primarily in that that here oval sound-attenuating openings 41 are worked into the cover layer 4 turned toward the acoustic source, and running through it. These openings 41 provide access for the sound to the slanted-fiber layer 5 following the openings 41 with the slanted cavities 6, 6′ that here function as sound-attenuating cavities that here destroy sound energy through multiple reflection.

A brief explanation should be made for FIGS. 6-12 that the building boards 1 used there have at least one slanted-fiber core layer 5, symbolized by a slanted line, preferably one such of slanted-fiber simple or multiple strips 50, 50′, as this slanted-fiber core layer 5 is always assembled individually.

It should be clarified, and this holds true for the specification, the patent claims and the drawings, that the expression “slanted fiber” in connection with strips, layer and the like, is to be read as “slanted cavity,” when wood plastic material is used, especially as no distinctive wooden material of the core layer having texturing.

With the meanings of the reference symbols otherwise remaining the same, FIG. 13 shows—in a step, as of one—building board 1, with curvature here exaggerated, a slanted-fiber slant cavity dual strip (50, 50′) is placed between a lower concave cover layer 3 and an upper convex cover layer 4, with reinforcement strips 7 beneath, each with their longitudinal edge abutting each other and from there tending outwards toward the upper cover layer 4 at a small acute angle.

At this point it should be clearly indicated that the wooden rods obtained when making grooves in the planks can be used as a valuable material for generation of filler materials in the plastics industry, for wood plastic, for obtaining wood gas and various derivatives, for methamine and alcohol production, for fuel and the like.

1. Building board or structural unit, especially a structural, wall, paneling or support unit or the like with a multi-layer structure, preferably based on wood or wooden materials, which is formed with two cover layers that are spatially separated from each other and placed parallel to each other and at least one core layer placed between them and joined to them,
characterized in that
between two if necessary multilayer cover layers (3, 4) each with a planar, preferably compact, layer, plate or foil material, preferably from the wood and wooden material group, such as laminated wood, plywood, wood chip material or wood plastic, as well additionally as metals, textile and fiber materials, cardboard, papers plastics, fiber-reinforced plastics, mineral-based construction materials, rock, artificial stone as well as composite materials made of two or more of the materials just named, as a core layer, at least one single-layer slanted-fiber core layer (5), joined to the named cover layers (3, 4) is placed, which is formed from a material having unitary structuring, whose fibers or whose structuring forms or form an angle ( [symbol] ) to the longitudinal direction of the two cover layers (3, 4) of +25 to 80°, especially +30 to 80°, especially of +40° to 60°, and/or an angle ( [symbol] ) of −25 to −80°, preferably from −30 to −80°, especially from −40° to −60°, and whereby additionally provision is made
that the slanted-fiber core layer (5) has a multiplicity of these same positively-slanted and/or negatively-slanted slant cavities (6, 6′) that fully run through, are aslant to the particular fiber direction, preferably of equal size to the other, and preferably uniformly distributed.

2. Building board or structural unit, especially a structural, wall, paneling or support unit or the like with a multi-layer structure, preferably based on wood or wooden materials, which is formed with two cover layers that are spatially separated from each other and placed parallel to each other and at least one core layer placed between them and joined to them, according to claim 1,
characterized in that
between two if necessary multilayer cover layers (3, 4) each with a planar, preferably compact, layer, plate or foil material, preferably from the wood and wooden material group,
such as laminated wood, plywood, wood chip material or wood plastic, as well additionally as metals, textile and fiber materials, cardboard, papers, plastics, fiber-reinforced plastics, mineral-based construction materials, rock, artificial stone as well as composite materials made of two or more of the materials just named, as a core layer, at least one single slanted-fiber core layer (5), joined to the named cover layers (3, 4) is placed, which is formed by slanted-fiber strips (50, 50′) that lie on each other on the longitudinal side and are joined together on the longitudinal side, each made of material, preferably of wood or wood plastic, each of which has material unitary per strip (50, 50′) containing a positively-slanted or negatively-slanted direction or formed with such or with such a slanted structuring or fiber structure, whereby the slanted fiber strips (50, 50′) that adjoin each other and are preferably joined to each other each alternately one to one or each in rows or series of more than one identically positively-slanted or negatively-slanted, slant fiber strips 50 or 50′ alternately
once (50) or in multiples have an essentially unitary positively-slanted slant-fiber direction and a multiplicity of slanted cavities (6), recesses, notches, boreholes or the like, that run fully through and essentially are parallel to each other and to the positively-slanted slant fibers, whereby the positively-slanted slant fibers and slant cavities (6), recesses, notches and the like extend at a positive acute angle [symbol] to the longitudinal direction of the cover layers (3, 4) of +25 to 80°, especially +30 to 80°, especially of +40° to 60°, and preferably +40° to 50°, and
once (50) or in multiples have an essentially unitary negatively-slanted slant-fiber direction and a multiplicity of slanted cavities (6), recesses, notches, boreholes or the like, that run fully through and essentially are parallel to each other and to the negatively-slanted slant fibers, whereby the negatively-slanted slant fibers and slant cavities (6), recesses, notches and the like extend at a negative acute angle [symbol] to the longitudinal direction of the cover layers (3, 4) of −25 to 80°, especially −30 to 80°, especially of −40° to 60°, and preferably −40° to 50°.

3. Building board or structural unit according to claim 1,
characterized in that the slanted-fiber strips (50, 50′) of the core layer (5) placed within the slanted-fiber slant cavity core layer from woods identical to each other or wood plastics, are formed from woods differing from each other and/or wood plastic, whereby in the case of a core layer (5) made of wood plastic, there are no slanted fibers, but the slanted cavities (6, 6′) are present in the same way as in the core layer (5) made of natural woods having fibers or a structuring.

4. Building board or structural unit, especially a structural, wall, paneling or load-bearing element or the like, with a multilayer structure, preferably based on wood material, according to claim 1, which is formed by two cover layers placed at an interval to each other and parallel to each other, and at least one core layer placed between same and joined with them,
characterized in that
between two if necessary multilayer cover layers (3, 4) each with a planar, preferably compact, layer, plate or foil material, preferably from the wood and wooden material group, such as laminated wood, plywood, wood chip material or wood plastic, as well additionally as metals, textile and fiber materials, cardboard, papers, plastics, fiber-reinforced plastics, mineral-based construction materials, rock, artificial stone as well as composite materials made of two or more of the materials just named, as a core layer, at least one single-layer slanted-fiber core layer (5), joined to the named cover layers (3, 4) is placed, which is formed from plastic-bound wood or wood plastic with a multitude of positively-slanted and/or negatively-slanted slant cavities (6, 6′), whereby the cavities (6) form an angle ( [symbol] ) to the longitudinal direction of the two cover layers (3, 4) of +25 to 80°, especially +30 to 80°, especially of +40° to 60°, and/or an angle ( [symbol] ) of −25 to −80°, preferably from −30 to −80°, especially from −40° to −60°.

5. Building board or structural unit according to claim 1,
characterized in that
its or their core layer (5) is formed by two slanted-fiber partial layers (T1, T2) that lie flat on each other and are joined to each other, whose slanted-fiber core layer (5) formed each in its makeup of the alterating positively-slanted and negatively-slanted slant-fiber strips (50, 50′) alternating with each other one to one or each in rows of more than one strip (50, 50′), is formed whereby one of the partial layers (T1, T2) or the direction of the course of the slanted-fiber strips (50, 50′) that form them is placed at an angle ( [symbol] ) of 30° to 120°, if necessary from 30° to 60°, preferably at an angle essentially of 90°, to each other partial layer (T2, T1) or to the course of the slanted-fiber strips (50, 50′) that form same, or the positive and negative slanted-fiber strips of the two partial layers (T1, T2) of the core layer (5) are configured parallel to each other.

6. Building board or structural unit according to claim 1,
characterized in that
its or their core layer (5) is formed between the cover layers (3, 4) by three slanted-fiber partial layers (T1, T2, T3) that lie flat on each other and are joined to each other, each in its structure appropriately embodied of the slanted-fiber core layer, whereby
either the first and the third partial layer (T1) and (T3) has slanted-fiber strips (50, 50′) that are directed aslant parallel to each other, and the second partial layer (T2) placed between same (T1, T3) is placed at an angle in the range from 30° to 120°, if necessary from 30° to 60°, preferably at an angle essentially of 90°, to the other two partial layers (T1, T3),
or, the second partial layer (T2) is turned relative to the first partial layer (T1) essentially at 120° and the third partial layer (T3) is turned relative to the second partial layer (T2) essentially by an additional 120°.

7. Building board or structural unit according to claim 1,
characterized in that
a thin interlayer, preferably of wood or a wooden material, is placed between the partial layers (T1, T2) or (T1, T2, T3) and is joined with the partial layers (T1, T2) or (T1, T2, T3).

8. Building board or structural unit according to claim 1,
characterized in that
in the slanted-fiber core layer (5), a positive (50) and a negative (50′) slanted-fiber strip is placed, alternating with each other, in each case laterally lying on each other and laterally joined to each other, or
in the slanted-fiber core layer (5), more than one positively-slanted slanted-fiber strip (50) and in an equal number more than one negatively-slanted slanted-fiber strip (50′) are placed next to each other, and that each of these join in themselves and laterally to one another more than one slanted-fiber strip (50, 50′) encompassing multiple strips.

9. Building board or structural unit according to claim 1,
characterized in that
its slanted-fiber core layer (5) is formed by a preferably even number of, especially by two, slanted-fiber partial layers (T1, T2 . . . ), each of whose positively-slanted and/or negatively-slanted slanted-fiber strips (50, 50′) is formed with the longitudinal side lying one on another and joined one to another,
whereby all the positive slanted-fiber strips (50) of the first partial layer (T1) have the same unitary positively-slanted slant-fiber direction and a multiplicity of positively-slanted slant cavities (6), recesses, cuts, boreholes and the like, in essence positively slanted parallel to the slanted fibers, which fully pass through the positively-slanted slant-fiber strips (50),
whereby the positively-slanted slant fibers and slant cavities (6), recesses, cuts, boreholes and the like extend at a positive acute angle to the planar extension of the deck plates (3, 4) of +25 to +80°, preferably +30 to +80°, especially of +40° to +60°, preferably from +40° to +50°, and
whereby all the negative slanted-fiber strips (50) of the second partial layer (T2) have the same unitary negatively-slanted slant-fiber direction and a multiplicity of negatively-slanted slant cavities (6′), recesses, cuts, boreholes and the like, in essence negatively slanted parallel to the slanted fibers, which fully pass through the negatively-slanted slant-fiber strips (50),
whereby the negatively-slanted slant fibers and slant cavities (6′), recesses, cuts, boreholes and the like extend at a negative acute angle to the planar extension of the deck plates (3, 4) of −25 to −80°, preferably −30 to −80°, especially of −40° to −60°, preferably from −40° to −50°.

10. Building board or structural unit or the like according to claim 1,
characterized in that
the slanted cavities (6, 6′) in the slanted-fiber core layer (5) or in a partial layer (T1, T2, T3 . . . ) of same or in the slanted-fiber strips (50, 50′) of same in essence have cavity cross sections possessing equal surface area and/or geometric shape, and/or are essentially equidistant from each other in the direction of longitudinal extension of the slanted-fiber strips (50, 50′).

11. Building board or structural unit or the like according to claim 1,
characterized in that
the relation of the entirety of the cross sectional surface of the slanted cavities (6, 6′) in the slanted-fiber core layer (5) or in its partial layers (T1, T2, T3 . . . ) to the entirety of the cross sectional surface(s) (Qm) of the slanted fiber material forming same, preferably wood, and if necessary wood plastic, amounts to between 5:1 and 1:5, preferably between 2:1 and 1:2.

12. Building board or structural unit or the like according to claim 1,
characterized in that
the interior walls and the base of the positively-slanted and negatively-slanted slant cavities (6, 6′) of the positively-slanted and negatively-slanted slant fiber strips (50, 50′) of the slanted-fiber core layer (5) or their partial layers (T1, T2, T3 . . . ) are coated with an intumescing polymer mass that protects against fire or prevents fires from propagating, which expands due to heat action in the case of a fire and fills the slanted cavities (6, 6″), such as for example on the basis of silicates containing structured water.

13. Building board or structural unit or the like according to claim 1,
characterized in that
the positively-slanted and negatively-slanted slant cavities (6, 6′) of the slant-fiber core layer (5) or of it partial layers (T1, T2, T3) are filled with an artificial-resin light foam mass, especially based on polyurethane, polyacryl or the like.

14. Building board or construction element or the like according to claim 1,
characterized in that
the slanted-fiber core layer (5) and especially the positively-slanted and negatively-slanted slanted-fiber strips (50, 50′), each having identically slanted cavities (6, 6′) that form same, is or are formed with a multiplicity of slanted-fiber bodies lined up on each other and/or in the longitude on each other, with at least two of their small front and lateral flank surfaces placed to lie on each other and joined to each other in material-locked fashion, preferably made of wood, and if necessary of wood plastic.

15. Building board or structural unit or the like according to claim 1,
characterized in that
the slanted-fiber core layer (5) or the partial layers (T1, T2, T3) that form same, is shaped with positively-slanted and/or negatively-slanted slant-fiber strips (50, 50′) that are placed with their flank surfaces (55) lying on one another, and are bound to one another, each with an essentially comb-like cross sectional shape with base and comb beams (53) that are arrayed essentially perpendicular to the cover surfaces (3, 4) and tooth extensions or toothed ribs (52) that project away from same, preferably at a right angle, but positively slanted or negatively slanted to the longitudinal extension of the strips (50, 50′) and to the cover layers (3, 4), whereby the interdental spaces (54) between same form the slanted cavities (6, 6′) of the slanted-fiber layer (5) parallel to the particular positively-slanted or negatively-slanted slant fibers.

16. Building board or structural unit or the like according to claim 15,
characterized in that
the interdental spaces (54) or the slanted cavities (6, 6′) of the slanted-fiber strips (50, 50′) are embodied as grooves, slits, channels that are parallel to each other, preferably are formed by cutting, and if necessary in the case with wood plastic provided with fibers, by extrusion, preferably one beneath the other essentially of the same depth, size and width or cross-sectional surface and/or cross sectional shape.

17. Building board or structural unit or the like according to claim 15,
characterized in that
the interdental spaces (54) of the slanted-fiber strip bodies (51) or of the slanted cavities (6, 6′) of the slanted-fiber layer (5) have essentially elongated parallelogram shapes and right-angle cross-sectional shapes, if necessary with a rounded base, whereby the rectangular length in relation to the rectangular width is (10:1) to (1:1), preferably (5:1) to (1:1) and if necessary (5:2) to (4:3).

18. Building board or structural unit or the like according to claim 15,
characterized in that
in the case of the roughly comb-like shape of the cross section of the slanted-fiber strips (50, 50′), the width (br) of the interdental spaces (54) is one half to double the width (bz, bb) of the tooth extensions or toothed ribs (52) and/or of the comb beam (53), however it is preferred that the named widths (br, bb, bz) essentially be equal to one another.

19. Building board or structural unit or the like according to claim 1,
characterized in that
the slanted-fiber core layer (5) formed by the positively-slanted and negatively-slanted cavities (6) is formed with straight-line slanted positively-slanted and negatively-slanted fiber strips (50, 50′) placed in rows directly onto each other, having the same width among them,
which are placed either directly lying direct on each other longitudinally or joined one to another,
whereby for this case it is preferred that the two cover layers (3, 4) are shaped from (thin if necessary) compact wooden fixing plates or homogenous plates or wood plastic plates, without a distinct fiber direction, or
that between each of such adjoining positively-slanted and negatively slanted slanted-fiber strips (50, 50′) adjoining on their vertical longitudinal flanks turned toward each other, reinforcement or stiffening strips (7) made of wood, plastic or the like are placed that run parallel to each other and preferably are joined to same,
whereby for this last-named case it is preferred if the two cover layers (3, 4) are made of wood, whose structuring or fibers are parallel to each other, but perpendicular to the direction of the longitudinal extension of the reinforcing strips (7) and of the structuring of same extending in the longitudinal direction of the reinforcing strips (7).

20. Building board or structural unit or the like according to claim 1,
characterized in that
the reinforcement or stiffening strips (7) have an elongated cross section, and for a case when they essentially have the same physical property alteration behavior when the environmental conditions change, in a direction transverse to the longitudinal direction of the cover layers (3, 4) as do the slanted-fiber strips (50, 50′) or with the slanted-fiber layer (5) formed with same, —with their upper and lower side, (narrow) side surfaces or upper and lower surfaces joined in material-locking fashion to the cover layers (3, 4).

21. Building board or structural unit or the like according to one of claim 1,
characterized in that
the reinforcement or stiffening strips (7) have an elongated rectangular cross section and for a case when they have a different physical property alteration behavior in a direction perpendicular to the cover layers (3, 4) or to their structuring, when the environmental conditions are altered from the slanted-fiber strips (50, 50′) or with the slanted-fiber core layer (5) formed with same, they in fact adjoin with their longitudinal side surfaces bilaterally onto the slanted-fiber strips and are joined to same, however with their two (narrow) side surfaces or upper and lower surfaces not formed within to adjoin the cover layers (3, 4) and are not joined to same, and their narrow side surfaces are separated to a corresponding amount from the cover layers (3, 4) to the degree of expansion transverse to the expansion or the like of the named strips (7) when environmental conditions change.

22. Building board or structural unit or the like according to claim 1,
characterized in that
for the preferred case that both of their cover layers (3, 4) are formed with a direction of the fibers or structuring of the material that forms them, preferably of the wood that forms them, that is essentially identical among them or parallel to each other, the reinforcing or stiffening strips (7) in the slanted-fiber core layer (5) in its longitudinal extension are so arranged that the longitudinal extension of the reinforcing strips (7) and of the fibers or structuring of the material that forms them, preferably wood, run or runs essentially perpendicular to the direction of the fibers or structuring of the two cover layers (3, 4).

23. Building board or structural unit or the like according to claim 1,
characterized in that
the slanted-fiber core layer (5) or that which forms same or the slanted-fiber strips (50, 50′) is or are formed of or with a customary wood, especially oak, spruce, pine, poplar, willow from or with one such wood of lesser quality or from or with a lightweight wood such as balsa, okume, abachi or wawa, with a density in the range from 0.1 to 0.8 g/cm³.

24. Building board or structural unit or the like according to claim 1,
characterized in that
the cover layers (3, 4) are formed with materials identical to each other, preferably with woods identical to each other and/or with material thicknesses identical to each other, or
that the cover layers (3, 4) are formed with materials differing from each other, as especially with types of wood differing from each other and/or with material thicknesses differing from each other, but with essentially equal physical and if necessary direction-dependent equal alteration behavior or the like, when the environmental conditions change, such as when temperature, humidity or the like are altered.

25. Building board or structural unit or the like according to claim 1,
characterized in that
these or this is closed at least on two narrow-side flanks, that run opposite each other, and preferably on all of them, with cover strips (2) joined to same, preferably of wood.

26. Building board or structural unit or the like according to claim 1,
characterized in that
between a concave-curved, preferably lower cover layer (3) and a preferably upper, equally convex-curved cover plate (4), preferably curved, with its lower longitudinal edges lying on one another and toward the top, a slanted-fiber core layer (5) is placed with alternating individual positive and negative slanted-fiber strips (50, 50′), tending outwards to match the curvature of the deck plates (3, 4), or with dual slanted-fiber strips (50, 50′).

27. Building board or structural unit or the like according to claim 1,
characterized in that
it is embodied as a sound-attenuation or acoustic board, preferably of wood, and toward the acoustic source it essentially either has no cover layer whatever, or its cover layer (4) that is turned toward the acoustic source, is embodied with the same through-running acoustic passage openings (41) preferably arranged and shaped to accord with a particular desired design, and the slanted-fiber layer (5) and its slanted cavities (6) are directly acoustically accessible through these openings (41), whereby for safety reasons it is preferred if the interior walls of the slanted cavities are coated with a fire protection polymer mass that expands or intumesces when subject to heat action in case of a fire, or
that the building board (1) is embodied as a vibration and resonance board, for example for bases and covers of noise generating and propagating devices, especially speaker boxes, musical instruments or the like, whereby if necessary one of its cover surfaces (3, 4) is embodied with the same through-running acoustic propagation openings, and the slanted-fiber core layer (5) and its slanted cavities (6, 6′) are capable of noise propagation through these openings.

28. Building board or structural unit or the like according to claim 1,
characterized in that
it is embodied as a safety building board, especially as a door leaf, with two cover layers (3, 4) made for example from wood or from a wooden material, and the slanted-fiber core layer (5) which preferably is present, which has, in the slanted cavities (6, 6′) formed with wood and if necessary coated with intumescing fire-retardant material or filled with lightweight foam, of reinforcing or stiffening strips (7) placed at intervals from each other and arranged parallel to each other, and made of a metal, preferably of steel or aluminum, and/or
that on at least one of the cover layers (3, 4) of wood, on the outer side, a metal plate, foil or the like is adhesive-joined, or, that in place of the cover layers of wood, a metal plate, foil or the like is directly joined to the slanted-fiber core layer (5), whereby it is preferred that an adhesive that expands or intumesces due to heat action in case of a fire be used to join the metal plate, foil or the like to the particular cover layer (3, 4) or to the core layer (5).

29. Building board, structural unit or the like, especially a wall, partition or ceiling unit or board with high thermal, acoustic and footstep-noise damping effectiveness, for new construction, development and renovation of structures, spaces or the like, characterized in that
it is formed with at least two building boards (1, 1′) according to claim 1, that are essentially match each other in the manner of their basic construction and are held at a distance from each other by means of spacer bodies (91), preferably made of wood, and are arranged parallel to each other and connected by these with each other, preferably with such building boards (1, 1′) whose two cover layers (3, 4) consist of wood, laminated wood, plywood, wood chip material, wood plastic or the like, and also whose slanted fiber core layer (5) consists of wood or if necessary wood plastic.

30. Building board or structural unit or the like according to claim 1,
characterized in that it is embodied with the building board (1), preferably able to be load-bearing, or with more than one such building board (1) joined flat one to the other, on which, to attain greater fire safety, at least on one side, a board (1) built in a similar manner that prevents the spread of fire, with two cover layers (3, 4) and a slanted-fiber core layer (5) placed between same—preferably with wood such as oak that is flame and combustion resistant, with slanted cavities (6), however with a small size or thickness, especially 2 to 5 cm, whereby the inner wall and possibly also the base of the slanted cavities (6) of the slanted-fiber core layer (5) are coated with a fire-protection polymer mass that expands and intumesces when exposed to heat in the case of fire.

31. Building board or structural unit or the like, especially a wall, partition or ceiling unit or board, according to claim 30,
characterized in that it is formed with three building boards (1, 1′, 1″), that are kept apart from each other by spacer bodies (91) —essentially, as embodied according to this claim and at least fundamentally as arranged there.

32. Building board or structural unit or the like, especially a wall, partition or ceiling unit or board, as per claim 31,
characterized in that the spacer bodies (91) are so formed in the voids or intermediate spaces (90) between the building boards (1, 1′) each with one or more slanted-fiber strips (50, 50′), preferably made of wood, joined to each other, having the slanted cavities (6, 6′) and slanted fibers or structuring, that their structuring also runs at a positive or negative acute angle to the main longitudinal direction of the building boards (1, 1′).

33. Building board or structural unit or the like, especially a wall, partition or cover element or board, with high thermal, acoustic and footstep-noise damping effectiveness, for new construction, development and renovation of structures, spaces or the like, characterized in that
it is formed with at least two building boards (1, 1′) according to claim 1, that essentially match each other in the manner of their basic construction and are held at a distance from each other by means of spacer bodies (91), preferably made of wood, and are arranged parallel to each other and connected by these with each other, preferably with such building boards (1, 1′) whose two cover layers (3, 4) consist of wood, laminated wood, plywood, wood chip material, wood plastic or the like, and also whose slanted fiber core layer (5) consists of wood or if necessary wood plastic, whereby the spacer bodies (91) are formed by bodies—that have an open pore structure or free cavities—especially by mineral or plastic-based foam or pore bodies or preferably by pipe pieces running transverse to the longitudinal direction of the cover layers (3, 4), and of the intermediate space (90) between the building boards (1, 1′) provided if necessary with a steel reinforcement (92) filled with Leca, light construction material, light foam material and/or a mineral-based, hardening or hardened binder, like concrete, especially lightweight or porous concrete (95) or the like.

34. Building board or structural unit or the like, especially a wall, partition or ceiling unit or board according to claim 33,
characterized in that
the surfaces of the cover layers (3, 4) turned toward the intermediate space (90) between the building boards (1, 1′) and/or the exterior surfaces of same, are provided with an adhesion-promoting layer (19), sand covering, foil, network or the like, or with a thin slanted-fiber core layer (5), especially up to a maximum of 1 cm thick, but without cover layers for an adhesive or close connection of the binder, concrete, lightweight concrete or the like with the building boards (1, 1′) inserted into the intermediate space (90).

35. Building board or structural unit or the like, especially a wall, partition or ceiling unit or board (9) according to claim 27,
characterized in that at least one of the exterior cover layers (3, 4) of building board (1, 1′) is provided with a plaster base layer, foil, network (181) or the like that at minimum resists moisture but preferably permits diffusion of vapor, especially based on a plastic, for example an epoxy adhesive, with a sand coating or the like that enhances adhesion, or with a thin slanted-fiber core layer (5), especially up to a maximum of 1 cm, but without cover layers.

36. Building board or structural unit or the like, especially a wall, partition or ceiling unit or board according to claim 26,
characterized in that it is produced directly at a construction or installation site locally as a wall, partition or ceiling, in that the two building boards (1, 1′) were positioned as formwork boards of a “lost formwork” connected with each other via the spacer bodies (91) and placed at an interval from each other with a steel reinforcement (92) inserted into the intermediate space (90) between same, and the intermediate space (90) just named is filled with a hardened binder, preferably concrete, light concrete (95) or the like, and at least one of the building boards (1, 1′) on its outside is able to be provided or is provided with a plaster or patent plaster layer (18), whereby it is preferred if a thin, preferably up to a maximum of 1 cm, slanted-fiber layer, is provided as the plaster base for same, but without cover layers.

37. Building board or structural unit or the like, especially a wall, partition or ceiling unit or board (9′″),
characterized in that it is formed with a building board (1) according to claim 1, onto which an (interior) permanent layer (190) is joined to at least one cover layer, preferably onto both cover layers (3, 4) on the outside, with at least one lightweight board, if necessary having fire resistant and/or moisture and water deflecting properties, especially with a sandwich-type plaster board or a water- and fire-resistant mineral plate.

38. Building board or structural unit or the like, especially a wall, partition or ceiling unit or board according to claim 1,
characterized in that it is formed with a building board (1) whose (interior) permanent layer (190) is provided on the outside with a plaster base (181) or with a ready plaster layer (18) surrounding the named plaster base.

39. Procedure for manufacturing building boards or structural units according to claim 1, characterized in that
in a first operational step, a multiplicity of longitudinal grooves (60) parallel to each other and to the wood structuring direction are cut into planks (58) or strips of wood in the longitudinal extension direction, and thus into the wood-fiber or structuring direction at preferably equal intervals from each other, while retaining ribs that are preferably identical and parallel to each other,
that in a second step, while forming a first layer (LI), the planks (58) which are provided with longitudinal grooves (60)—related to a center line (ml) or to the forward direction of processing (VR)—are placed laterally one behind the other at a positive acute angle ( [symbol] ) to the center line (ml),
that onto the first layer (LI) thus formed, preferably with grooves (60) open downward or upward, a second layer (LII) is applied, likewise with identical planks (58) placed laterally one behind the other and provided with longitudinal grooves (60), preferably at an identical but negative acute angle ( [symbol] ) to the center line (ml), and the two layers LI and LII of grooved planks 58 arranged crosswise to each other are joined,
that in a second step, the just-described combination of grooved planks (58) placed crosswise over each other in the forward direction of processing (VR) are continuously fed through a (hot) press (HP) or the like and joined to a slanted-fiber board,
that in a third step, (dual or multiple) slanted fiber strips (50, 50′) are formed by means of cuts (S) made at intervals to each other, in each case matching the desired thickness of the building board to be produced, perpendicular to the center line (ml) or to the forward motion direction (VR) of processing,
that in a fourth step each of the (dual) slanted-fiber strips (50-50′) is turned forward or backward by +90° or −90° about its longitudinal axis
that in a fifth step, the (dual) slanted-fiber strips (50, 50′) thus turned are applied, glued and joined side to side to each other, thus forming a slanted-fiber core layer (5) on a lower cover layer (3) of wood or wooden material or the like, and
that in a sixth step, the upper cover layer (4) of wood or wooden material or the like is applied onto the (dual) slanted-fiber strips (50, 50′) joined to each other and to the lower cover layer (3) and onto the slanted-fiber core layer (5) formed with same, and—preferably simultaneously—a material-locking connection is made of the slanted-fiber core layer (5) to the two cover layers (3, 4).

40. Procedure for manufacturing building boards or structural units according to claim 1, characterized in that
in a first step, a multiplicity of longitudinal grooves (60) that are parallel to each other and to the wood structuring direction are cut into planks (58) or strips of wood, in the direction of longitudinal extension and thus in the wood fiber or structuring direction, at preferably equal intervals to each other, while leaving preferably identical ribs parallel to each other,
that in a second step, while forming a first layer (LI), the planks (58) which are provided with longitudinal grooves (60)—related to a center line (ml) to the forward direction of processing (VR) —are placed laterally to adjoin each other, one behind the other, at a positive acute angle + [symbol] to the center line (ml),
that in a first intermediate step, an intermediate layer (Zl) of wood, preferably with a structuring at a right angle to the center line (ml) or to the processing direction (VR), is applied onto the grooved planks (58) of the first layer (LI), that lie one on another, and is preferably joined to the ribs between the grooves (60) of the planks (58) of the first layer (LI), and
a second layer (LII) likewise of identical planks (58) provided in the same manner with longitudinal grooves (60) and likewise laterally lying on each other, is applied onto the first layer (LI) thus formed, or onto the intermediate layer (ZI), preferably with grooves (60) that are open downward or toward the named intermediate layer (Zl), with a preferably identical, but negative acute angle (− [symbol] ) to the center line (ml), and the first layer (LI), the intermediate layer (ZI) and the second layer (LII) are joined flat to one another,
that in a second step, the just-described combination of a first and second layer (LI, LII) of grooved planks (58) and intermediate layer (ZI) placed between same in the forward direction of processing (VR) are continuously fed through a (hot) press (HP) or the like and joined to a slanted-fiber board,
that in a third step, by means of separating cuts (S) made at intervals to each other, in each case matching the desired thickness of the building board to be produced, (dual or multiple) slanted fiber strips (50, 50′) are formed perpendicular to the center line (ml) or to the forward motion direction (VR) of processing,
that in a fourth step each of the (dual) slanted-fiber strips (50-50′) is turned forward or backward by +90° or −90° about its longitudinal axis
that in a fifth step, the (dual) slanted-fiber strips (50, 50′) thus turned, each having a reinforcing strip (7) between them, are applied, glued and joined side to side to each other, thus forming a slanted-fiber core layer (5) on a lower cover layer (3) of wood or wooden material or the like, and
that in a sixth step, the upper cover layer (4) of wood or wooden material or the like is applied onto the (dual) slanted-fiber strips (50, 50′) with reinforcing strips (7), joined to each other and to the lower cover layer (3) and onto the slanted-fiber core layer (5) formed with same, and—preferably simultaneously—a material-locking connection is made of the slanted-fiber core layer (5) to the two cover layers (3, 4).

41. Procedure according to claim 39, characterized in that
in accord with the principle of forming the core layer (5) of layers LI and LII, at least once more additional layers LI and LII are applied in the same manner onto the first two layers LI and LII, and the slanted-fiber core layer 5 of the building boards is formed from the quadruple and sextuple strips obtained via the separating cut (S).

42. Procedure according to claim 39, characterized in that the angles ( [symbol] and [symbol] ) of the slanted direction to the center line (ml) or to the direction of feed (VP), of the grooved planks (58) that preferably are continuously fed, and placed crosswise to each other, or of their fibers and longitudinal grooves (60) are plus or minus [90° minus (25 to 80°, preferred 30 to 80°, preferably 40°) to 60°, especially 40° to 50°].

43. Procedure according to claim 39,
characterized in that
preferably in the course of cutting the longitudinal grooves (60) into the planks (58), strips or the like, or manufacturing same through extrusion, the grooves (60) are acted on or sprayed while wetting the groove walls and groove base of the slanted cavities (6, 6′) of their core layer (5) with a flame retardant, preferably with an intumenscing polymer, especially based on hydrosilicate, and/or
that the basis for a foaming plastic, that results in a lightweight foam when heated, is inserted into the grooves (60).

44. Use of building boards or structural units or the like according to claim 1, either directly as a lightweight, separating and if necessary load-bearing units, especially as walls, partitions, (intermediate) covers, (intermediate) floors and the like for new construction, rebuilds and development of structures, containers, residential containers, especially ready-component structures, that are mobile if necessary, or paneling boards or the like that come into use if necessary according to a “lost formwork” type, especially as thermal and acoustic damping plates and insulation plates, for structures and construction structures.

45. Use of building boards or structural units or the like according to claim 1 as high-strength lightweight shell plates in the construction trade.

46. Use of building boards or structural units or the like according to claim 1 for equipping structures, structural components and accommodations, rooves, cellars and the like, of structures with thermal and acoustic protection linings and panelings.

47. Use of building boards or structural units or the like according to claim 1 in accordance with their being formed by at least one slanted-fiber core layer (5), whose slanted cavities (6, 6′) are coated with a mass that protects from fire or contains fire and which expands or intumesces due to heat action in case of fire, and/or that at least on one side they are provided with a fireproof mineral plate or similar fireproof coating that is joined to it, or at least one fireproof mineral plate joined to its cover layers, for the equipping of structures, structural parts and accommodations, rooves, cellars and the like of structures with fire protection as well as thermal and acoustic panelings.

48. Use of building boards or structural units or the like according to claim 1 for interior equipping of buildings and accommodations, especially for pivoting and sliding doors, safety doors and the like.

49. Use of building boards or structural units or the like according to claim 1 for construction of homes, containers, ships, boats, mobile homes, recreational vehicles and campers, directly or especially as sandwich plates for lightweight equipping of motor vehicles and aircraft, ships, boats, mobile homes and the like as floors, panelings, internal fittings, built-in furniture, and the like.

50. Use of building boards or structural units or the like according to claim 1 for creating halls, berths, stands, setup and development in the fair, exhibition, presentation and market industry.

51. Use of building boards or structural units or the like according to claim 1 for building furniture as well as for accessory items of interior furnishings and equipping of buildings.

52. Use of building boards or structural units or the like according to claim 1 to construct instruments, preferably for resonance and vibration plates of acoustic emission devices such as speaker boxes, especially for ceilings and floors, of (stringed) instruments and the like.

53. Use of slanted-fiber core layers according to claim 1 that are thin, preferably up to a maximum of 10 mm thick, but without cover plates, as a plaster base or plaster carrier and/or as an adhesion layer for hardening binders, especially concretes.

54. Building boards or structural units according to claim 1,
characterized in that
it is embodied via a slanted-fiber core layer (5) without cover plates as described in these claims.

55. Building board, structural unit or the like, especially a wall, partition or ceiling unit or board with high thermal, acoustic and foot-step-noise damping effectiveness, for new construction, development and renovation of structures, spaces or the like, characterized in that
it is formed with at least two building boards (1, 1′) according to claim 1 that essentially match each other in the manner of their basic construction, and are joined to each other via their main surfaces, preferably by flat gluing, preferably with that kind of building board (1, 1′) whose two cover layers (3, 4) consist of wood, laminated wood, plywood, wood chip material, wood plastic or the like, and also whose slanted-fiber core layer (5) consists of wood or if necessary wood plastic.
